(19) United States
(12) Patent Application Publication
(10) Pub. No.: US 2005/0145053 A1
(43) Pub. Date: Jul. 7, 2005

(54) Linear to angular movement converter

(76) Inventors: Qing Bai, Sunnyvale, CA (US); Storrs Townsend Hoen, Brisbane, CA (US); Jonah Alexander Harley, Mountain View, CA (US); Kirt Reed Williams, Portola Valley, CA (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/752,183

(22) Filed: Jan. 7, 2004

(51) Int. Cl. F16M 13/00

(52) U.S. Cl. 74/469

(57) ABSTRACT

A device includes first and second supports, a rotatable body and first and second flexible members. The first flexible member extends between the first support and a first position on the rotatable body. The second flexible member extends between the second support and a second position on the rotatable body. At least one of the supports is capable of linear movement in a first direction with respect to the other. The first position is offset from the second position in a second direction orthogonal to the first direction.

### BACKGROUND OF THE INVENTION

1. Field of the Invention

The present invention relates to a flexure system to convert linear to angular movement. In particular, the invention relates to Micro Electro Mechanical System (MEMS) structures for converting linear movement into angular movement.

2. Description of Related Art

A known flexural device used to convert linear movement to angular movement is described in a paper by Kiang et al., “Electrostatic comb drive-actuated micro mirrors for laser-beam scanning and positioning” in the Journal of Microelectromechanical Systems, Vol. 7, No. 1, March 1998. That device is driven by a linear comb drive through a hinge at the bottom of its mirror and rotates about two torsional bars that connect the mirror to a rigid frame. Another two flexural devices capable of similar movement translation are described in a paper by Comtois and Bright, “Surface micromachined polysilicon thermal actuator arrays and applications” in the Digest of Solid-State Sensor and Actuator Workshop, Hilton Head, S.C., pp. 174-177, June 1996. One of these devices uses a hinged mirror, in which the notched end of an actuator tether slides into a keyhole at the mirror's edge and the mirror rotates about its hinge as the actuator moves linearly. The other device uses a mirror mounted on a micro-gear driven by a thermal actuator. All of the devices have friction problems.

What is needed is a substantially frictionless conversion from the linear movement produced by a linear actuator into an angular movement.

### SUMMARY OF THE INVENTION

A device for conversion of linear to angular movement includes first and second supports, a rotatable body and first and second flexible members. At least one of the supports is capable of linear movement in a first direction with respect to the other. The first flexible member extends between the first support and a first position on the rotatable body. The second flexible member extends between the second support and a second position on the rotatable body. The first position is offset from the second position in a second direction orthogonal to the first direction.

A two-dimensional movement converter includes first and second supports, a rotatable body and first and second flexible structures. At least one of the first and second supports is capable of linear movement in a first direction with respect to the other. The first flexible structure extends between the first support and a first position on the rotatable body. The second flexible structure includes a pivot frame, an outer second flexible member and an inner second flexible member. The outer second flexible member extends between the second support and the pivot frame. The inner second flexible member extends between the pivot frame and a corresponding second position on the rotatable body. The first position is offset from the second position in a second direction orthogonal to the first direction.

### BRIEF DESCRIPTION OF DRAWINGS

The invention will be described in detail in the following description of preferred embodiments with reference to the following figures.

FIG. 1 is a perspective view of one embodiment of the present invention.

FIGS. 2 and 3 are section views showing operations of the embodiment of FIG. 1.

FIG. 5 is a perspective view of another embodiment of the invention.

FIG. 6 is a perspective view of the embodiment of FIG. 5 showing the effects of movement of one rigid member with respect to another.

FIGS. 7-9 are perspective views of other embodiments of the invention.

FIG. 10 is a perspective view of alternative torsion beam embodiments as used in the embodiments illustrated in FIGS. 5-7.

FIG. 11 is a perspective view of a two-dimensional movement converter embodiment of the invention.

FIG. 12 is a perspective view of another two-dimensional movement converter embodiment of the invention.

FIG. 13 is a perspective view of yet another two-dimensional movement converter embodiment of the invention.

FIG. 14 is a schematic diagram of another embodiment of the invention.

### DETAILED DESCRIPTION OF EXEMPLARY EMBODIMENTS

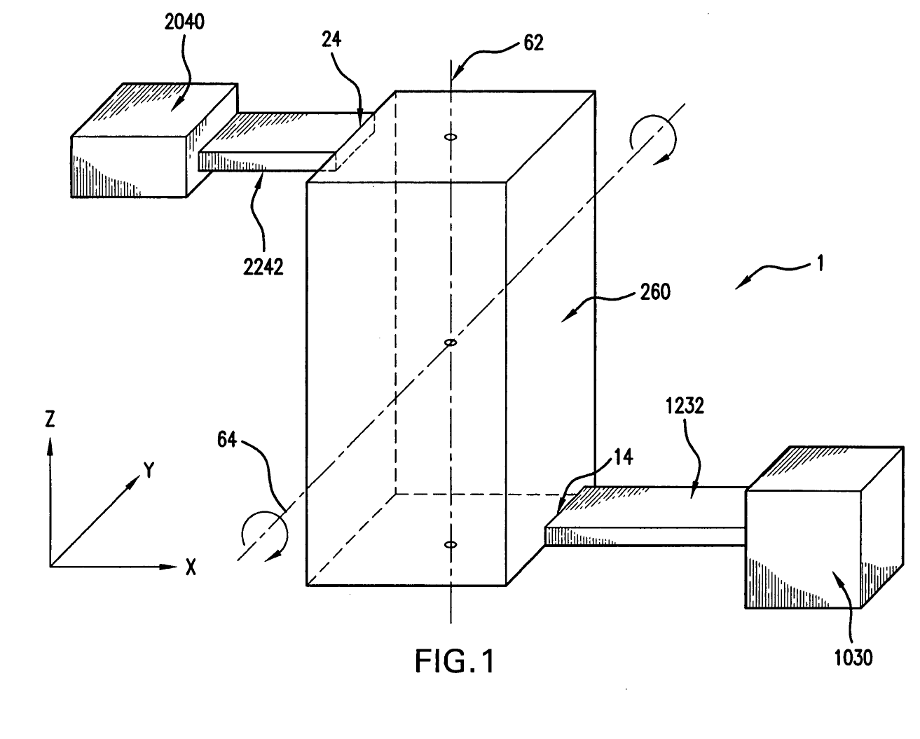

In an embodiment of the invention, a flexural device converts linear movement into angular (i.e., rotational) movement. In FIGS. 1-3, device 1 includes a first support 1030, a second support 2040 and a rotatable body 260. The device further includes a first flexible member 1232 extending between the first support 1030 and a first position 14 on the rotatable body 260. The device further includes a second flexible member 2242 extending between the second support 2040 and a second position 24 on the rotatable body 260.

Either the first support 1030 is capable of linear movement in a first direction with respect to the second support 2040, or the second support 2040 is capable of linear movement in the first direction with respect to the first support 1030, or both. More generally, at least one of the supports is capable of linear movement in the first direction with respect to the other. The linear movement of the two supports need not be collinear, and the linear movement of one support need not be along a line passing through the other support. Instead, the linear movement of one support with respect to the other support may be along a line that passes by and is spaced from the other support.

As depicted in FIG. 1, the first direction (i.e., the direction of the linear movement) is the X direction, and a second direction is defined orthogonal to the first direction (i.e., in the Z direction). The first position 14 is offset from the second position 24 in the second direction. An axis 62 exists within rotatable body 260 so that when body 260 rotates, the axis 62 rotates about rotation axis 64.

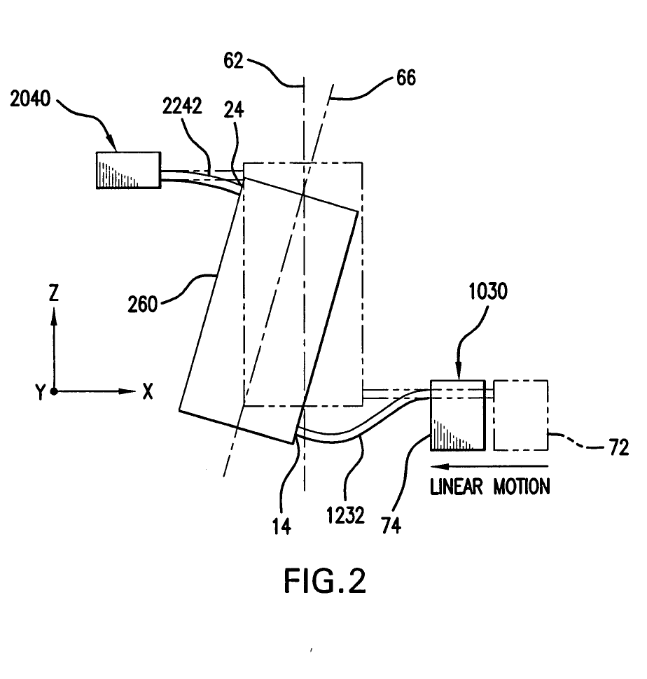

As an example of linear movement, in FIG. 2, the second support 2040 is fixed within a frame of reference, and the first support 1030 is part of, or is affixed to, the translator of a linear actuator whose stator is fixed within the same frame of reference. In operation, the translator of the actuator moves linearly from 72 to 74 so that the first support 1030 moves with respect to the second support 2040. The first and second flexible members 1232, 2242 bend as the rotatable body 260 rotates and the axis 62 rotates from its original position to a rotated position 66. In a variant of the above described embodiment, the first flexible member 1232 is flexible in a direction that allows the first position 14 to move transversely to the first direction (transversely to the X direction as depicted in FIGS. 1 and 2). Additionally or alternatively, the second flexible member 2242 is flexible in a direction that allows the second position 24 to move transversely to the first direction (transversely to the X direction as depicted in FIGS. 1 and 2) whether or not the first flexible member 1232 is able to move transversely to the first direction.

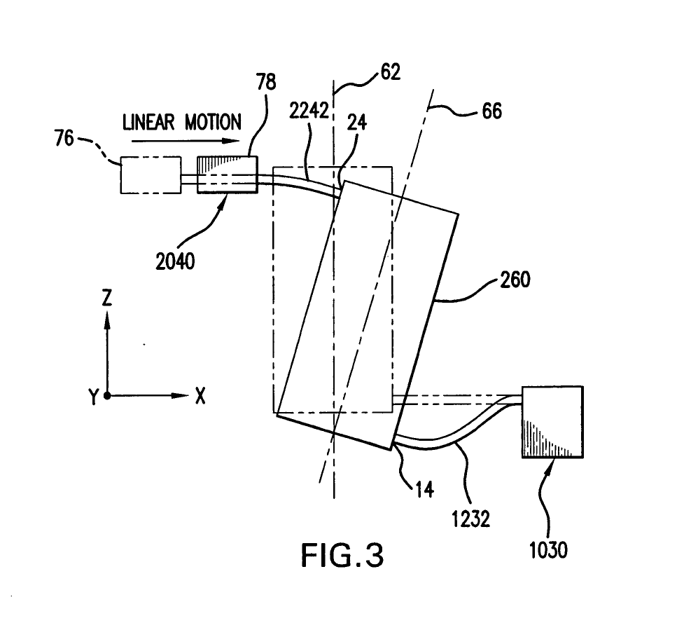

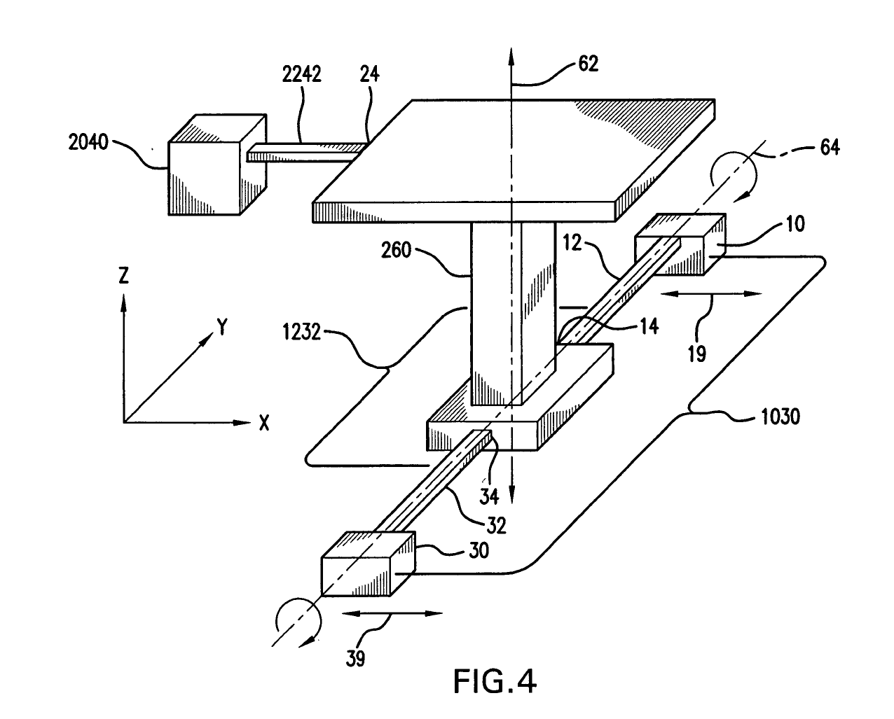

In FIG. 3, another variant is depicted in which the first support 1030 is fixed within a frame of reference, and the second support 2040 is part of, or is affixed to, the translator of a linear actuator whose stator is fixed within the same frame of reference. In operation, the translator of the actuator moves linearly from 76 to 78 so that the second support 2040 moves with respect to the first support 1030. The first and second flexible members 1232, 2242 bend as the rotatable body 260 rotates and the axis 62 rotates from its original position to a rotated position 66.

In yet another variant, both the first and second supports 1030, 2040 are part of, or are affixed to, translators of respective linear actuators whose stators are fixed with the same frame of reference. This variant has the advantage of enabling the actuators to adjust the translation in the X direction of the axis of rotation 64. The linear actuator(s) may be of any type, for example, a surface electrostatic drive, a comb drive, a piezoelectric drive, a magneto-electric drive, etc.

In operation, the rotatable body 260 behaves as a free body subject to the torques and forces applied at first and second positions 14, 24. The torques and forces apply a net torque to the rotatable body 260 that causes the rotatable body to rotate until the net torque is diminished to zero. When one of, or both of, the first and second supports 1030, 2040 moves linearly with respect to the other, there may be some resultant translation of the rotatable body 260 when the rotatable body 260 achieves equilibrium. The degree of translation depends on, among other factors, the shape and stiffness of the flexible members. As depicted in FIGS. 1-3, the first and second supports 1030, 2040 need not be the same in size or shape. Similarly, the first and second flexible members 1232, 2242 need not be the same in size or shape. The choices of size and shape reflect the designer's choices to achieve a particular degree of translation during a rotation operation or to achieve a particular proportionality between the amount of linear movement of the first or second supports and the resulting rotation of rotatable body 260.

Another embodiment of the device, depicted in FIG. 4, includes a first support 1030, a second support 2040 and a rotatable body 260. The first support 1030 includes a first support element 10 and a second support element 30. The device further includes a first flexible member 1232 that includes a first flexible element 12 and a second flexible element 32. The first flexible element 12 extends between the first support element 10 and a first position 14 on rotatable body 260. The second flexible element 32 extends between the second support element 30 and a third position 34 on the rotatable body 260. In this way, the first flexible element 12 of the first flexible member 1232 extends between the first support element 10 of the first support 1030 and the first position 14 on the rotatable body 260. The device further includes a second flexible member 2242 that extends between the second support 2040 and a second position 24 on the rotatable body 260.

Just as discussed above with respect to FIGS. 1-3, in the embodiment depicted in FIG. 4, either the first support 1030 is capable of linear movement in a first direction with respect to the second support 2040, or the second support 2040 is capable of linear movement in a first direction with respect to the first support 1030, or both. In particular, the linear movement of the first support element 10 is depicted in FIG. 4 in the X direction, and the linear movement of the second support element 30 is depicted in the X direction. More generally, at least one of the supports (either 1030 or 2040) is capable of linear movement in a first direction with respect to the other. The linear movement of the two supports need not be collinear, and the linear movement of one support need not be along a line passing through the other support. Instead, the linear movement of one support with respect to the other support may be along a line that passes by and is spaced from the other support.

As depicted in FIG. 4, the first direction (i.e., the direction of the linear movement) is the X direction, and a second direction is defined orthogonal to the first direction (i.e., in the Z direction). The first and third positions 14, 34 are each offset from the second position 24 in the second direction. An axis 62 exists within rotatable body 260 so that when body 260 rotates the axis 62 rotates as well.

Typically, but not necessarily, the first and third positions 14, 34 are disposed in a plane orthogonal to the second direction (i.e., parallel to the X-Y plane and orthogonal to a Z direction as depicted in FIG. 4). Also, the first and third positions 14, 34 are typically, but not necessarily, on opposite sides of the rotatable body 260.

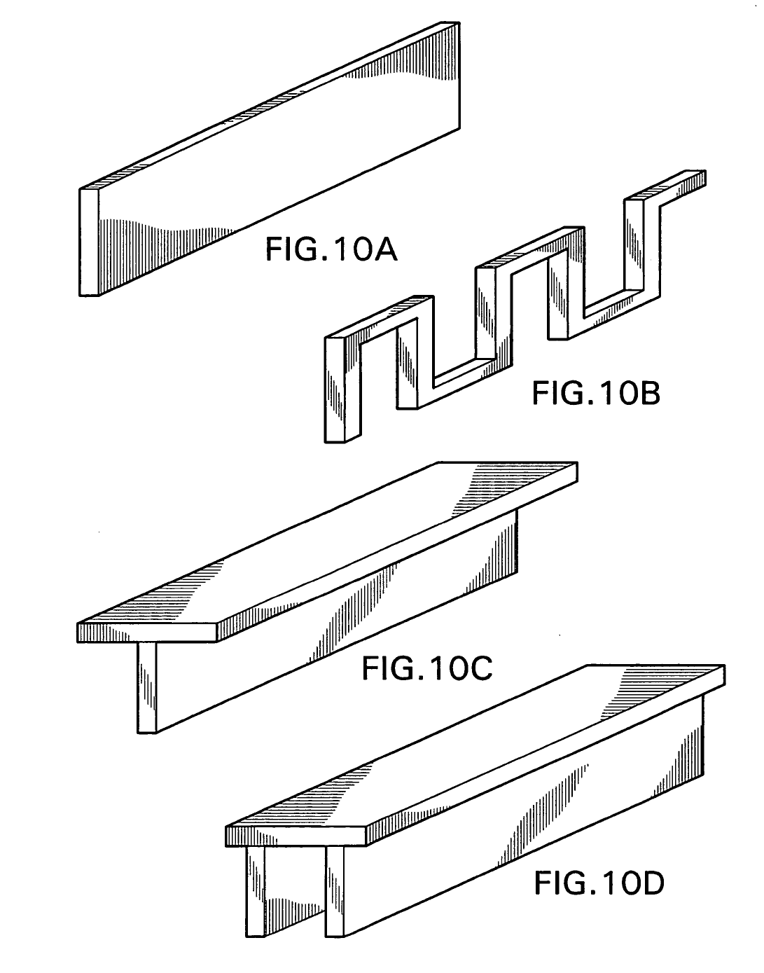

In a variant, each of the first and second flexible elements 12, 32 is formed from either a T beam or a pi beam as described in more detail below with respect to FIG. 10. As discussed below, the T beam and the pi beam have the property that they are relatively compliant to torsion forces but are relatively stiff to bending forces. In this way, an axis of rotation 64 tends to be aligned along the T or pi beams when the second flexible member 2242 is relatively compliant to bending forces. With such characteristics, the first and third positions 14, 34 on the device depicted in FIG. 4 would move very little in the second direction (the Z direction in FIG. 4) while moving in the first direction (the X direction in FIG. 4), but the second flexible member 2242 would flex in a direction that would allow the second position 24 to move transversely to the first direction (i.e., transversely to the X axis in FIG. 4).

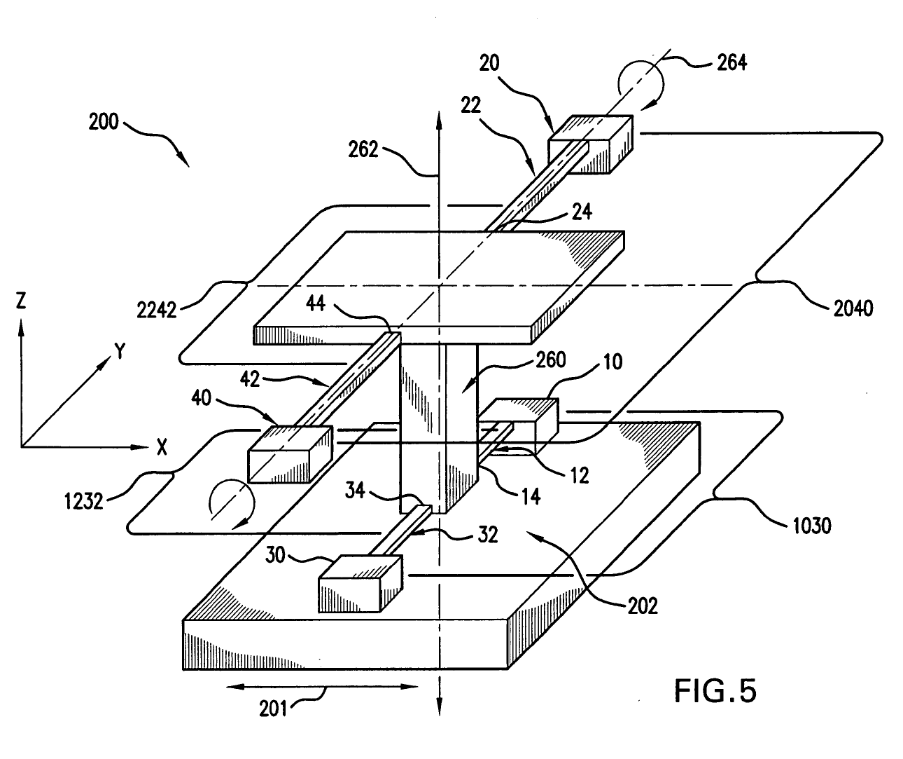

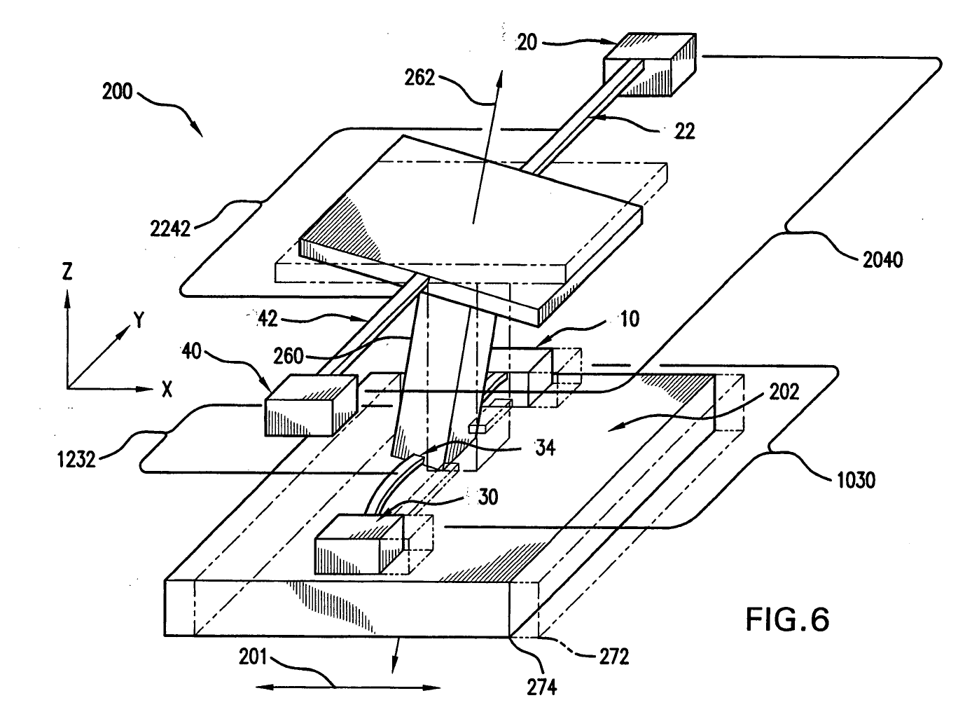

In another embodiment, depicted in FIGS. 5 and 6, a movement converter device 200 includes a first support 1030 that includes a first support element 10 and a second support element 30, a second support 2040 that includes a third support element 20 and a fourth support element 40 and further includes a rotatable body 260. The device further includes a first flexible member 1232 that includes a first flexible element 12 and a second flexible element 32. The first flexible element 12 extends between the first support element 10 and a first position 14 on rotatable body 260. The second flexible element 32 extends between the second support element 30 and a third position 34 on the rotatable body 260. In this way, the first flexible element 12 of the first flexible member 1232 extends between the first support (i.e., first support element 10 of the first support 1030) and the first position 14 on the rotatable body 260. The device further includes a second flexible member 2242 that includes a third flexible element 22 and a fourth flexible element 42. The third flexible element 22 extends between the third support element 20 and a second position 24. The fourth flexible element 42 extends between the fourth support element 40 and a fourth position 44 on the rotatable body 260. In this way, the third flexible element 22 of the second flexible member 2242 extends between the second support (i.e., the third support element 20 of the second support 2040) and the second position 24 on the rotatable body 260.

Just as discussed above with respect to FIG. 4, in the embodiment depicted in FIGS. 5 and 6, either the first support 1030 is capable of linear movement in a first direction with respect to the second support 2040, or the second support 2040 is capable of linear movement in the first direction with respect to the first support 1030, or both. In particular, in FIGS. 5 and 6, the linear movement of the first support 1030 is depicted in a direction 201. More generally, at least one of the supports is capable of linear movement in a first direction with respect to the other. The linear movements of the two supports need not be collinear, and the linear movement of one support need not be along a line passing through the other support. Instead, the linear movement of one support with respect to the other support may be along a line that passes by and is spaced from the other support.

As depicted in FIGS. 5 and 6, the first direction 201 (i.e., the direction of the linear movement) is the X direction, and a second direction is defined orthogonal to the first direction (i.e., in the Z direction). The first and third positions 14, 34 are each offset from each of the second and fourth positions 24, 44 in a second direction orthogonal to the first direction. An axis 262 exists within rotatable body 260 so that when body 260 rotates the axis 262 rotates as well. In operation, the first and third support elements 10, 30 move in first direction 201 as a pair relative to the second and fourth support elements 20, 40 as depicted at 201 in FIGS. 5 and 6.

Typically, but not necessarily, the first and third positions 14, 34 are disposed in a plane normal to the second direction (i.e., the Z direction as depicted in FIG. 5). Also, the first and third positions 14, 34 are typically, but not necessarily, on opposite sides of the rotatable body 260.

Similarly, the second and fourth positions 24, 44 are typically, but not necessarily, disposed in a plane normal to the second direction (the Z direction as depicted in FIG. 5). Typically, but not necessarily, the second and fourth positions 24, 44 are opposite one another on the rotatable body 260, and the first and third positions 14, 34 are on opposite sides of the rotatable body 260.

In a variant, each of the third and fourth flexible elements 22, 42 is formed from either a T beam or a pi beam as described in more detail below with respect to FIG. 10. As discussed below, the T beam and the pi beam have the property that they are relatively compliant to torsion forces but are relatively stiff to bending forces. In this way, an axis of rotation 264 tends to be aligned along the T or pi beams, when the first flexible member 1232 is relatively compliant to bending forces. With such characteristics, the second and fourth positions 24, 44 on the device depicted in FIGS. 5 and 6 would move very little in the second direction (the Z direction in FIGS. 5 and 6) while the first support 1030 moves in the first direction 201 (the X direction in FIG. 5), and the first flexible member 1232 flexes in a direction that would allow the first and third positions 14, 34 to move transversely to the first direction (i.e., transversely to the X axis in FIGS. 5 and 6).

When the second flexible member 2242 has a T or pi section and is compliant to torsion forces but is stiff to bending forces, then the first flexible member 1232 is typically, but not necessarily, compliant to torsion forces to allow rotation of the rotatable body 260 and also flexible in a direction that allows the first and third positions 14, 34 to move transversely to the first direction. This tends to align the axis of rotation 264 along the second flexible member 2242.

Conversely, when the first flexible member 1232 has a T or pi section and is compliant to torsion forces but is stiff to bending forces, then the second flexible member 2242 is typically, but not necessarily, compliant to torsion forces to allow rotation of the rotatable body 260 and also flexible in a direction that allows the second and four positions 24, 44 to move transversely to the first direction. This tends to align the axis of rotation 264 along the first flexible member 1232.

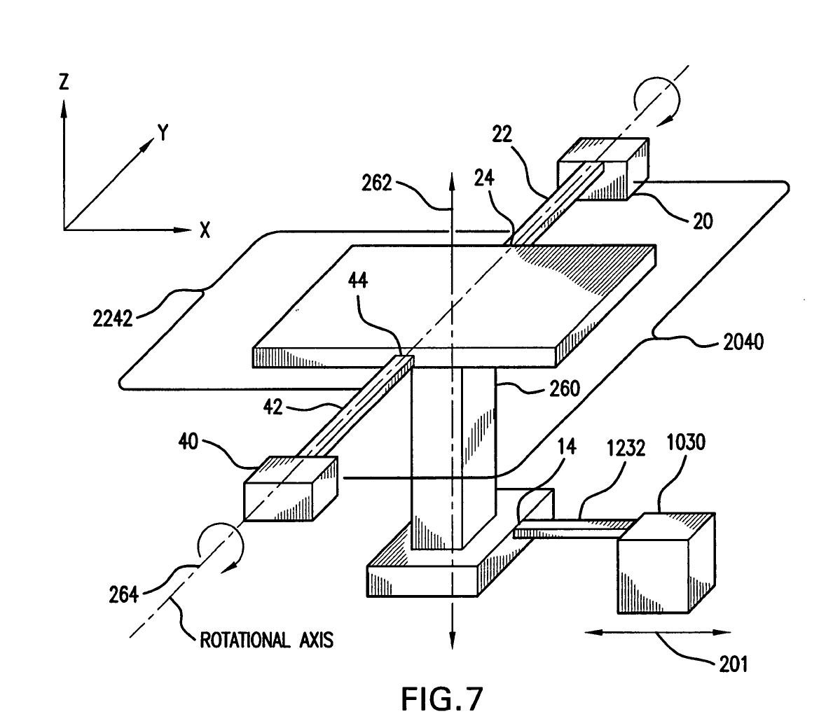

In another embodiment, depicted in FIG. 7, the device includes a first support 1030, a rotatable body 260 and a second support 2040 that includes a first support element 20 and a second support element 40. The device further includes a first flexible member 1232 extending between the first support 1030 and a first position 14 on the rotatable body 260. The device further includes a second flexible member 2242 that includes a first flexible element 22 and a second flexible element 42. The first flexible element 22 extends between the first support element 20 and a second position 24. The second flexible element 42 extends between the second support element 40 and a third position 44 on the rotatable body 260. In this way, the first flexible element 22 of the second flexible member 2242 extends between the second support (i.e., the first support element 20 of the second support 2040) and the second position 24 on the rotatable body 260.

Just as discussed with respect to FIG. 4, in the embodiment depicted in FIG. 7, either the first support 1030 is capable of linear movement in a first direction 201 with respect to the second support 2040, or the second support 2040 is capable of linear movement in the first direction with respect to the first support 1030, or both. More generally, at least one of the supports is capable of linear movement in the first direction with respect to the other. The linear movement of the two supports need not be collinear, and the linear movement of one support need not be along a line passing through the other support. Instead, the linear movement of one support with respect to the other support may be along a line that passes by and is spaced from the other support.

As depicted in FIG. 7, the first direction (i.e., the direction of the linear movement) is the X direction, and a second direction is defined orthogonal to the first direction (i.e., in the Z direction). The first position 14 is offset from each of the second and third positions 24, 34 in the second direction. An axis 262 exists within rotatable body 260 so that when body 260 rotates the axis 262 rotates as well.

Typically, but not necessarily, the second and third positions 24, 34 are disposed in a plane parallel to the X-Y plane and orthogonal to the second direction (i.e., the Z direction as depicted in FIG. 7). Also, the second and third positions 24, 34 are typically, but not necessarily, on opposite sides of the rotatable body 260.

In a variant, each of the first and second flexible elements 22, 42 is formed from either a T beam or a pi beam as described in more detail below with respect to FIG. 10. As discussed below, the T beam and the pi beam have the property that they are relatively compliant to torsion forces but are relatively stiff to bending forces. In this way, an axis of rotation 264 tends to be aligned along the T or pi beams, when the first flexible member 1232 is relatively compliant to bending forces. With such characteristics, the second and third positions 24, 34 on the device depicted in FIG. 7 would move very little in the second direction (the Z direction in FIG. 7) while the first position 14 moves in the first direction (the X direction in FIG. 7) as depicted at 201 and in the second direction. The first flexible member 1232 would flex in a direction that would allow the second position 24 to move transversely to the first direction (i.e., transversely to the X axis in FIG. 7).

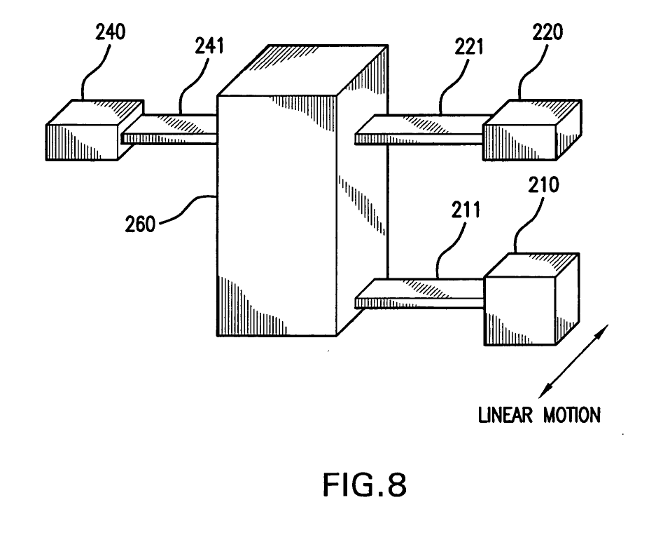

It should be noted that many modifications and variations can be made in these type of devices in light of the above teachings. For example, the various flexible members between the supports and the rotatable body may extend in different directions than the directions depicted in the examples above. For example, FIG. 7 depicts a flexible member 1232 aligned parallel to the first direction (i.e., the direction of linear movement) and flexible elements 22, 42 orthogonal to the direction of linear movement so they can twist under torsion forces. In contrast, FIG. 8 depicts a flexible member 211 extending between first support 210 and rotatable body 260 in a direction orthogonal to the direction of linear movement. The flexible elements 221, 241 extend between the rotatable body 260 and support elements 220, 240 in a direction orthogonal to the direction of linear movement so they can twist under torsion forces. In this situation, the flexible member 211 extending between first support 210 and rotatable body 260 is configured to be stiff to bending forces that may arise due to the linear movement, but flexible so that body 260 is free to rotate and exert torsion forces on the flexible elements 221, 241 extending between the rotatable body 260 and support elements 220, 240.

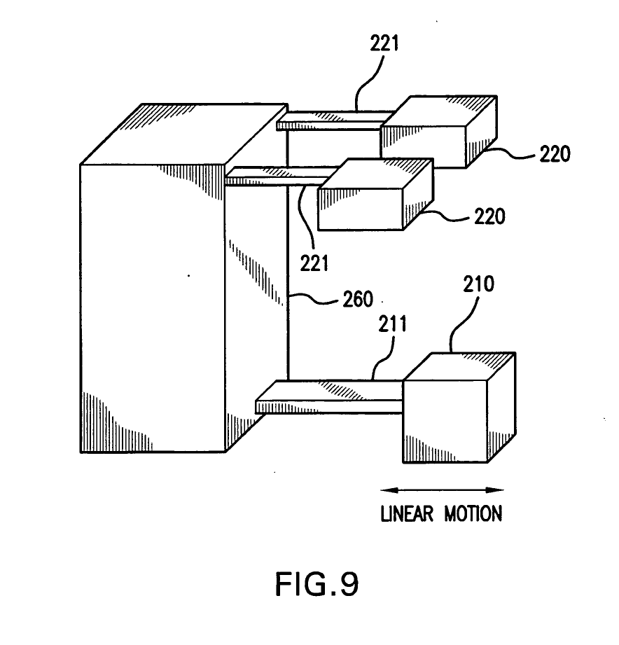

As another example of the many types of variations possible, FIG. 1 depicts the flexible member 1232 extending between rotatable body 260 and support 1030 and the flexible member 2242 extending between rotatable body 260 and support 2040 as extending from opposite sides of rotatable body 260. However, FIG. 9 depicts the flexible member 211 extending between rotatable body 260 and support 210 and the flexible member 221 extending between rotatable body 260 and support 220 as extending from the same side of rotatable body 260. In FIG. 9, the flexible member 221 extending between rotatable body 260 and support 220 is depicted as including two parallel flexible elements. A flexible member may be comprised of one or more distinct elements.

The number of, location of and variations in the flexible members may vary, as may their dimensions or shape.

The devices depicted in FIGS. 4-7 permit pairs of flexible members on the same end of the rotatable body to be designed to stiffen the flexible members against bending stress but make the flexible members more compliant to torsional forces. The converter devices described herein offer several advantages over prior art. The devices exhibit a high spring constant and corresponding high resonant frequency due to the stiffness of at least some of the flexible members to bending stresses. The more compliant the flexible members are to torsional forces, the more improved will be the range of angular rotation and better proportionality between the linear movement of the translator and the angular rotation of the rotatable body. The devices have vibration modes with high resonant frequencies. High rotational compliance of the flexible members means that the device needs only low drive force to rotate, achieves a large rotational angle, performs highly proportional conversion of linear movement into angular movement, and introduces low strain (and thus low fatigue) to the flexible members in the device. Such a device has a clean rotational movement, good immunity to environmental noise coupling, less stringent packaging requirements, and fast movement transition (or fast switching speed in optical switching applications).

Typical designs of the flexible members that may be used for either the flexible member or torsion rod functions in the movement converters are summarized in FIG. 10. These designs include a flat flexible member A, a meander flexible member B, a T-shaped flexible member C, and a pi shaped flexible member D. Such flexible members may be oriented vertically, as shown at A and B, or oriented horizontally (not shown), or at any angle between. Using a combinations of flat horizontal flexible members or flat vertical flexible members A, meander horizontal flexible members or meander vertical flexible members B, or a T-shaped flexible members C or pi shaped flexible members D, these devices can achieve highly linear conversion of the linear movement at low drive force and with high resonant frequencies. One of the applications for such a structure is to steer a light beam where a micro machined silicon device (also called a micro mirror) is attached to the rotational rigid body 260 and the converter is attached to a linear-movement drive (such as an electrostatic surface drive, an electrostatic comb drive, or a thermal actuator).

Movement converters such as these may be integrated with linear movement drives in one continuous fabrication process. The device and its linear movement drive may also fabricated separately and then joined together by methods of gluing, bonding, or others. The material of the flexural device (both rigid and flexible members) may be single-crystal silicon, poly-crystalline silicon, a dielectric material, metal, a combination of these materials, and others.

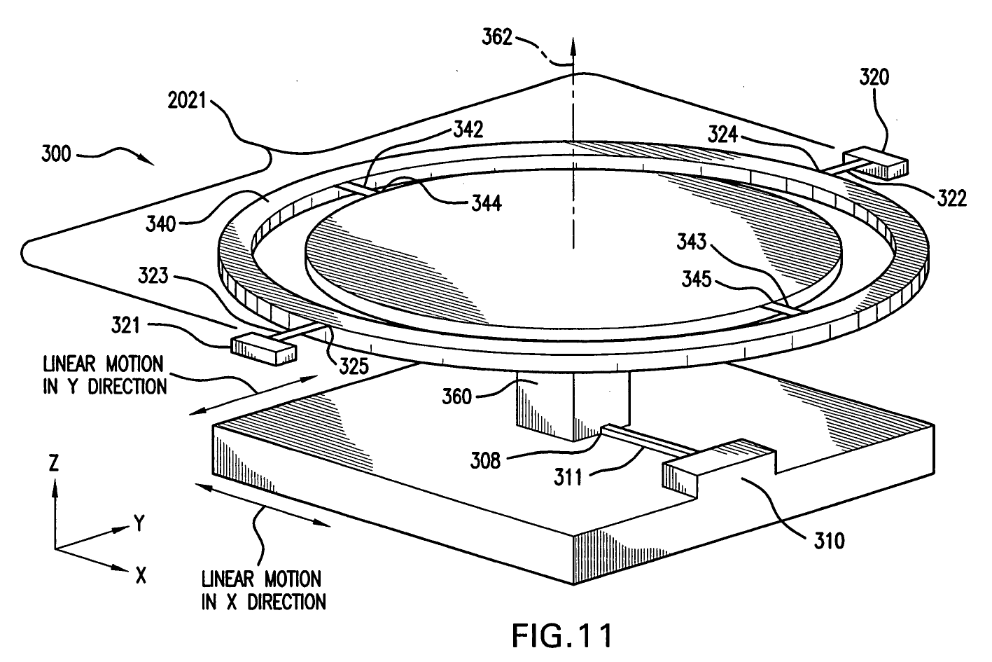

In addition to the movement converter devices described above, another embodiment of the invention, in the form of a two-dimensional (2D) converter 300, converts two dimensional linear movements along the X and Y directions into angular rotation of the rotatable body 360 about two axes of rotation as depicted in FIG. 11.

In FIG. 11, a two-dimensional movement converter 300 includes a first support 310, a rotatable body 360 and a second support 2021 which is comprised of a first support element 320 and a second support element 321. Movement converter 300 further includes a first flexible structure 311 and a second flexible structure which is comprised of a pivot frame 340, a first outer second flexible member 322 and a first inner second flexible member 342. The first outer second flexible member 322 extends between the first support element 320 of the second support and the pivot frame 340 at a position 324. The first inner second flexible member 342 extends between the pivot frame 340 and a position 344 on the rotatable body 360. In FIG. 11, the first flexible structure 311 includes a flexible member extending between the first support 310 and a first position 308 on the rotatable body 360.

Typically, but not necessarily, the first outer second flexible member 322 includes a flexible member having either a T-shaped or a pi-shaped section. Also typically, but not necessarily, the first the inner second flexible member 342 includes a flexible member having either a T-shaped or a pi-shaped section.

The second flexible structure typically, but not necessarily, also includes a second outer second flexible member 323 extending between the second support element 321 of the second support and the pivot frame 340 at a position 325. Also, the second flexible structure typically, but not necessarily, also includes a second inner second flexible member 343 extending between the pivot frame 340 and another position 345 on the rotatable body 360.

When the second flexible structure includes a second outer second flexible member 323, the first and second outer second flexible members 322, 323, typically, but not necessarily, include flexible members having either a T-shaped or a pi-shaped section. When the second flexible structure includes a second inner second flexible member 343, the first and second inner second flexible members 342, 343 also typically, but not necessarily, include flexible members having either a T-shaped or a pi-shaped section.

In the embodiment depicted in FIG. 11, either the first support 310 is capable of linear movement in a first direction (e.g. arbitrary direction in an the X-Y plane depicted in FIG. 11) with respect to the second support 2021, or the second support 2021 is capable of linear movement in the first direction with respect to the first support 310, or both. More generally, at least one of the supports is capable of linear movement in the first direction with respect to the other. The linear movement of the two supports need not be collinear, and the linear movement of one support need not be along a line passing through the other support. Instead, the linear movement of one support with respect to the other support may be along a line that passes by and is spaced from the other support.

As depicted in FIG. 11, the first direction (i.e., the direction of the linear movement) is an arbitrary direction within the X-Y plane, and a second direction is defined orthogonal to the first direction (i.e., in the Z direction normal to the X-Y plane). The first position 308 is offset from each of the positions 324, 344 in the second direction. An axis 362 exists within rotatable body 360 so that when body 360 rotates the axis 362 rotates as well.

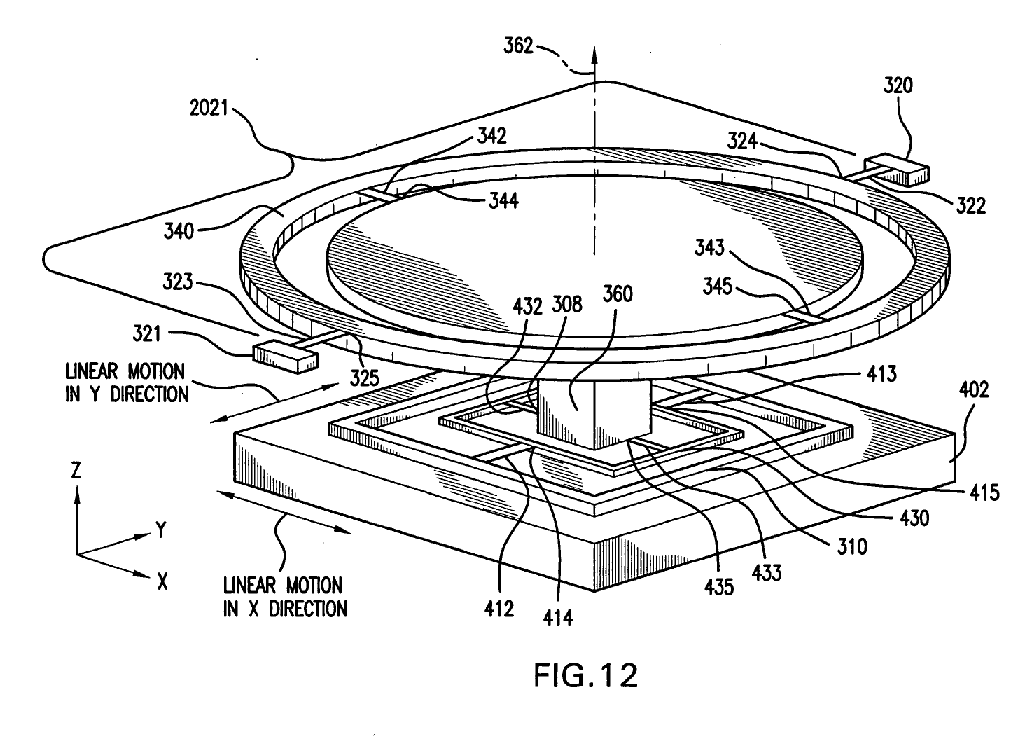

In FIG. 12, two-dimensional movement converter includes the same rotatable body 360 and second flexible structure as described above with respect to FIG. 11. However, in FIG. 12, the first flexible structure of FIG. 12 is different than the first flexible structure 311 described above with respect to FIG. 11. In FIG. 12, the first flexible structure includes a driving frame 430, a first outer first flexible member 412 and a first inner first flexible member 432. The first outer first flexible member 412 extends between the first support 310 and the driving frame 430 at a position 414. The first inner first flexible member 432 extends between the driving frame 430 and a first position 308 on the rotatable body 360. Typically, but not necessarily, the first outer first flexible member 412 and the first inner first flexible member 432 are each flexible in a direction that allows the first position 308 to move transversely to the first direction.

The first flexible structure typically, but not necessarily, also includes a second outer first flexible member 413 extending between the first support 310 and the driving frame 430 at a position 415. Also, the first flexible structure typically, but not necessarily, also includes a second inner first flexible member 433 extending between the driving frame 430 and another position 435 on the rotatable body 360. A line extending along the first and second outer first flexible members 412, 413 is orthogonal to a line extending along the first and second inner first flexible members 432, 433.

When the first flexible structure includes a second outer first flexible member 413 and flexible members with T-shaped or a pi-shaped sections are not used in the second flexible structure, the first and second outer first flexible members 412, 413, typically, but not necessarily, include a flexible member having either a T-shaped or a pi-shaped section. When the first flexible structure includes a second inner first flexible member 433, and flexible members with T-shaped or pi-shaped sections are not used in the second flexible structure, the first and second inner first flexible members 432, 433 also typically, but not necessarily, include a flexible member having either a T-shaped or a pi-shaped section.

The two elements of the second support 2021 may be a single frame that is rigid and has space in its center for the rest of the structure as described herein. The driving frame 430 has sufficient clearance around and under it to freely move when flexible members twist and bend as discussed herein.

When flexible members with T-shaped or pi-shaped sections are not used in the second flexible structure, the first and second outer first flexible members 412, 413 may be members with T-shaped or a pi-shaped sections to function as a compliant torsion rod between the first support 310 and the driving frame 430, and the first and second inner first flexible members 432, 433 may be members with T-shaped or a pi-shaped sections to function as a compliant torsion rod between the driving frame 430 and two positions on opposite sides of the rotational rigid member 360.

The first support 310 is attached to, or is otherwise part of, the translator of a two-dimensional (2D) actuator. The first support 310 is capable of linear movement in either of, or a combination of, the X and Y directions with respect to the second support 2021. As an example, the second support 2021 is fixed within a frame of reference (see coordinates X, Y and Z), and the first support 310 is part of, or affixed to, the translator of a 2D linear actuator whose stator is fixed within the same frame of reference.

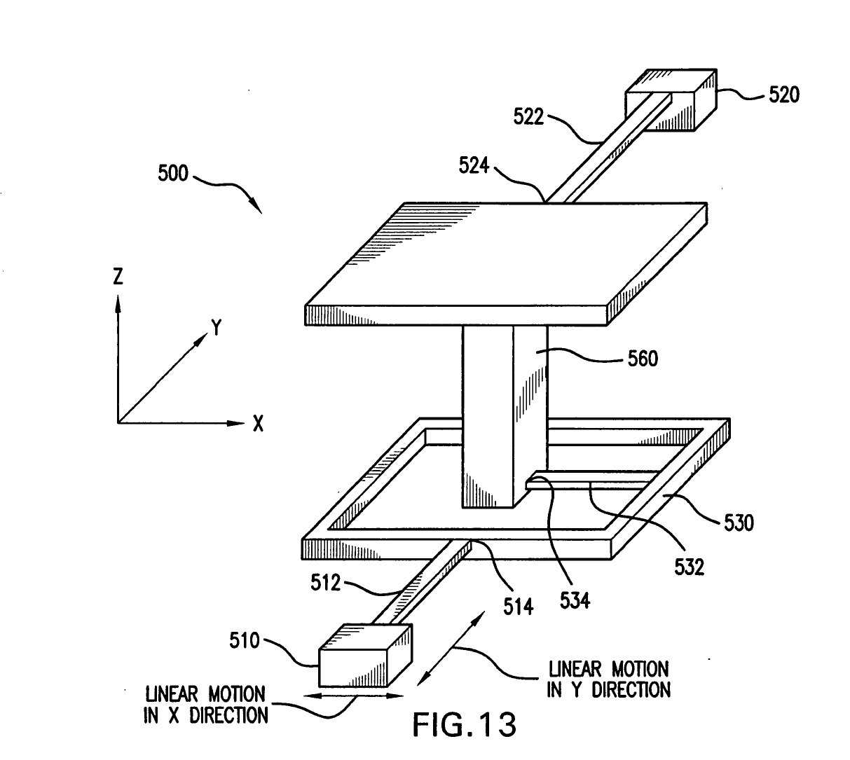

In yet another embodiment, depicted in FIG. 13, two-dimensional movement converter device 500 includes a first support 510, a second support 520, and a rotatable body 560. Movement converter 500 further includes a driving frame 530, an outer first flexible member 512 and an inner first flexible member 532, all of which constituting a first flexible structure. The outer first flexible member 512 extends between the first support 510 and the driving frame 530 at a position 514. The inner first flexible member 532 extends between the driving frame 530 and a first position 534 on the rotatable body 560. Also, movement converter 500 further includes a flexible member 522 that extends between the second support 520 and a second position 524 on the rotatable body 560. The flexible member 522 constitutes a second flexible structure.

In the embodiment depicted in FIG. 13, either the first support 510 is capable of linear movement in a first direction with respect to the second support 520, or the second support 520 is capable of linear movement in the first direction with respect to the first support 510, or both. More generally, at least one of the supports is capable of linear movement in the first direction with respect to the other. The linear movement of the two supports need not be collinear, and the linear movement of one support need not be along a line passing through the other support. Instead, the linear movement of one support with respect to the other support may be along a line that passes by and is spaced from the other support.

As depicted in FIG. 13, the first direction (i.e., the direction of the linear movement) is an arbitrary direction that lies in the X-Y plane, and a second direction is defined orthogonal to the first direction (i.e., in the Z direction). The first position 514 is offset from the second position 524 in the second direction.

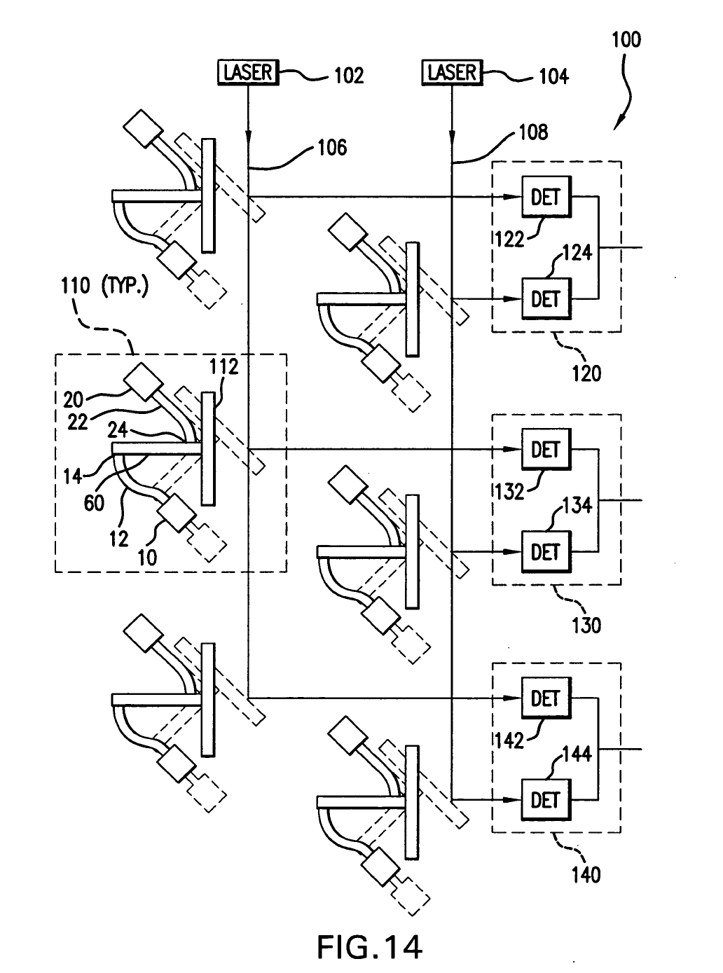

Another embodiment of the invention is depicted in FIG. 14. In FIG. 14, a beam steering device (such as an optical cross bar switch 100) includes an array of movement converters 110. The array is arranged in rows and at least one column. Switch 100 is depicted with two input channels receiving laser beams 106 and 108 from respective light devices (not shown). Any number of rows and columns may be provided.

Each movement converter 110 includes a first support 10, a second support 20 and a rotatable body 60 as discussed above with respect to FIG. 1. The rotatable body 60 includes a reflecting surface. The device further includes a first flexible member 12 extending between the first support 10 and a first position 14 on the rotatable body 60 also as discussed above with respect to FIG. 1. The device further includes a second flexible member 22 extending between the second support 20 and a second position 24 on the rotatable body 60 also as discussed above with respect to FIG. 1.

Movement converters 110 are preferably capable of rotating reflecting surfaces 112 between two angular positions that are, for example, 45 degrees apart, when used in a optical cross bar switch so that the reflected beam is redirected at about 90 degrees from the incident beam. Movement converters 110 move selected reflecting surfaces 112 into a first angular position that reflects laser beams 106 and 108, as the switch parameters demand, into selected output channels. Movement converters 110 move selected reflecting surfaces 112 into the second angular position away from the beam's path, also as the switch parameters demand. The signals in the output channels are output from switch 100. An optical cross bar switch can be made from any number of rows and columns of movement converters. In movement converters 110, the first flexible member 12 is capable of flexing so that the first position 14 is free to move transversely to the first direction.

Having described preferred embodiments of a novel linear to angular converter (which are intended to be illustrative and not limiting), it is noted that modifications and variations can be made in light of the above teachings. It is therefore to be understood that changes may be made in the particular embodiments of the invention disclosed which are within the scope of the invention as defined by the appended claims. What is claimed and desired protected by Letters Patent is set forth in the appended claims.

1. A device, comprising:
a first support;
a second support, at least one of the supports being capable of linear movement in a first direction with respect to the other;
a rotatable body;
a first flexible member extending between the first support and a first position on the rotatable body; and
a second flexible member extending between the second support and a second position on the rotatable body, the first position being offset from the second position in a second direction orthogonal to the first direction.

2. The device of claim 1, wherein the first flexible member is flexible in a direction that allows the first position to move transversely to the first direction.

3. The device of claim 1, wherein the first support comprises a first support element and a second support element, and wherein the first flexible member comprises:
a first flexible element extending between the first support element and the first position; and
a second flexible element extending between the second support element and a third position on the rotatable body, the third position being offset in the second direction from the second position.

4. The device of claim 3, wherein the first and third positions are disposed in a plane normal to the second direction.

5. The device of claim 3, wherein the first and third positions are on opposite sides of the rotatable body.

6. The device of claim 5, wherein each of the first and second flexible elements comprises one of a T beam and a pi beam.

7. The device of claim 3, wherein the second support comprises a third support element and a fourth support element, and wherein the second flexible member comprises:
a third flexible element extending between the third support element and the second position; and
a fourth flexible element extending between the fourth support element and a fourth position on the rotatable body, the fourth position being offset in the second direction from the third position.

8. The device of claim 7, wherein the second and fourth positions are disposed in a plane normal to the second direction.

9. The device of claim 7, wherein:
the second and fourth positions are opposite one another on the rotatable body; and
the first and third positions are on opposite sides of the rotatable body.

10. The device of claim 9, wherein each of the third and fourth flexible elements comprises one of a T beam and a pi beam.

11. The device of claim 1, wherein the second support comprises a first support element and a second support element, and wherein the second flexible member comprises:
a first flexible element extending between the first support element and the second position; and
a second flexible element extending between the second support element and a third position on the rotatable body, the third position being offset in the second direction from the first position.

12. The device of claim 11, wherein the second and third positions are disposed in a plane normal to the second direction.

13. The device of claim 11, wherein the second and third positions are on opposite sides of the rotatable body.

14. The device of claim 13, wherein each of the first and second flexible elements comprises one of a T beam and a pi beam.

15. A beam steering device comprising the device of claim 1, wherein the rotatable body includes a reflecting surface.

16. The beam steering device of claim 15, further comprising additional devices according to claim 1, the devices according to claim 1 being arranged in an array having at least one dimension.

17. A two-dimensional movement converter, comprising:
a first support;
a second support, at least one of the first and second supports being capable of linear movement in a first direction with respect to the other;
a rotatable body;
a first flexible structure extending between the first support and a first position on the rotatable body;
a second flexible structure comprising a pivot frame, an outer second flexible member extending between the second support and the pivot frame and an inner second flexible member extending between the pivot frame and a corresponding second position on the rotatable body, the first position being offset from the second position in a second direction orthogonal to the first direction.

18. The movement converter of claim 17, wherein the first flexible structure is flexible in a direction that allows the first position to move transversely to the first direction.

19. The movement converter of claim 17, wherein:
the outer second flexible member comprises one of a T beam and a pi beam; and
the inner second flexible member comprises one of a T beam and a pi beam.

20. The movement converter of claim 17, wherein the second flexible structure further comprises:
an additional outer second flexible member extending between the second support and the pivot frame; and
an additional inner second flexible member extending between the pivot frame and a corresponding third position on the rotatable body, the third position being offset in the second direction from the first position.

21. The movement converter of claim 20, wherein each of the outer second flexible member, inner second flexible member, additional outer second flexible member and additional inner second flexible member comprises one of a T beam and a pi beam.

22. The movement converter of claim 17, wherein the first flexible structure comprises:
a driving frame;
an outer first flexible member extending between the first support and the driving frame; and
an inner first flexible member extending between the driving frame and the first position on the rotatable body.

23. The movement converter of claim 22, wherein the outer first flexible member and the inner first flexible member are each flexible in a direction that allows the first position to move transversely to the first direction.

24. The movement converter of claim 22, wherein:
the outer second flexible member comprises one of a T beam and a pi beam; and
the inner second flexible member comprises one of a T beam and a pi beam.

25. The movement converter of claim 22, wherein the first flexible structure further comprises:
an additional outer first flexible member extending between the first support and the driving frame; and
an additional inner first flexible member extending between the driving frame and a third position on the rotatable body, the third position being offset in the second direction from the second position.
